(19) United States
(12) Patent Application Publication
(10) Pub. No.: US 2004/0268081 A1
(43) Pub. Date: Dec. 30, 2004

(54) Apparatus and method for storing digital data

(76) Inventor: Erwin Thalmann, Villach (AT)

Correspondence Address: JENKINS & WILSON, PA, 3100 TOWER BLVD, SUITE 1400, DURHAM, NC, 27707, US

(21) Appl. No.: 10/842,986

(22) Filed: May 11, 2004

(30) Foreign Application Priority Data
Jun. 30, 2003 (DE) 10329345.0

(51) Int. Cl. G06F 12/04

(52) U.S. Cl. 711/200

(57) ABSTRACT

The present invention provides an apparatus for storing digital data, having: a multiplicity of memory cells (21) for storing digital data (14); an internal address generation device (15), connected to an address logic device (22), for managing and generating addresses; an internal control device (16), connected to the internal address generation device (15) and a control logic device (23), for controlling the address generation device (15) and the control logic device (23); a trigger input (11), connected to the internal address generation device (15), for clocking the internal address generation device (15); a control input (12), connected to the internal control device (16), for actuating the internal control device (16); and a data input/output (13) for interchanging digital data (14) on the basis of a trigger signal (11′) and a control signal (12′). The present invention likewise provides a method for storing digital data.

The present invention relates to an apparatus and a method for storing digital data and, in particular, to a functionally extended main memory and a corresponding storage method.

RAM (Random Access Memory) stores are frequently used main memories, since it is possible to access any memory cell at will. In an ordinary computer system, a processor and a main memory normally have a controller provided between them which undertakes data transfer and data addressing. To be able to interchange digital data, it is always necessary to communicate appropriate commands for the desired functionality and hence to notify the main memory of the appropriate read or write addresses. An exactly defined transmission protocol therefore needs to be observed in order to ensure the data interchange function.

A main memory cannot be used alone in a computer system without a controller and a processor. If one wishes to use a RAM store in a simple system, this entails a considerable level of complexity for the processor. The processor needs to be provided with an appropriate level of functionality so that it can operate with the memory in the overall system. This high minimum demand on the processor also increases the overall costs of the system.

To utilize all of the functions with which a memory can be operated, the processor requires a high level of circuit complexity in a system comprising a main memory, a controller and a processor. If one wishes to operate the main memory using just one function, such as writing and completely reading long data streams, then the same level of circuit and system complexity is still required. A drawback in this context is the high level of circuit complexity for the overall system, regardless of whether just one particular, limited functionality of a system component, i.e. the main memory, is required or demanded.

It is therefore an object of the present invention to provide an apparatus and a method for storing digital data which can be used to reduce the overall complexity and hence the overall costs of a data processing system.

The invention achieves this object by means of the apparatus for storing digital data according to claim 1 and by means of the method for storing digital data according to claim 3. The idea on which the present invention is based essentially involves providing the main memory with a functional extension in order to be able to reduce the complexity of the processor in this way.

In the present invention, the aforementioned problem is solved, in particular, by providing an apparatus for storing digital data, having: a multiplicity of memory cells for storing digital data; an internal address generation device, connected to an address logic device, for managing and generating addresses; an internal control device, connected to the internal address generation device and a control logic device, for controlling the address generation device and the control logic device; a trigger input, connected to the internal address generation device, for clocking the internal address generation device; a control input, connected to the internal control device, for actuating the internal control device; and a data input/output for interchanging digital data. Such a circuit extension to the main memory reduces the memory's communication with an external controller to a minimum. Address lines and control lines are likewise reduced to a minimum of one line. To maintain the demanded data rates/transmission speeds, data lines are retained to an unaltered degree. The functional extension to the main memory is expressed in address management which is performed entirely internally in the main memory and reduces an internal control unit to a minimum. This allows simple writing and reading of data.

Just one respective line for an external control signal and an address signal is required. The functionality of a processor can therefore be reduced significantly, since only a simple transmission protocol needs to be observed. The main memory can thus be operated with much less circuit complexity in an overall system, resulting in a cost saving.

It is also possible to couple a standard system, i.e. a system having a high level of complexity for the processor, with the extended main memory, which can be operated with reduced address and control lines, but likewise works in the standard manner of operation, if desired. This results in the same production costs thus compared with a standard system, but increases the scope for using the computer system.

The subclaims contain advantageous developments and refinements of the respective subject matter of the invention.

In line with one preferred development, a first and a second address register are respectively connected to the address generation device for the purpose of interchanging addresses.

In line with another preferred development, a first and a second address register respectively interchange addresses with the address generation device on the basis of a trigger signal at the trigger input and on the basis of a control signal at the control input.

In line with another preferred development, data are stored in the memory cells on the basis of the FIFO principle.

In line with another preferred development, the data are stored in the memory cells on the basis of the FILO principle.

In line with another preferred development, data are written to the memory cells or are read therefrom when there is an appropriate external write or read signal at the control input and a trigger signal appears at the trigger input.

In line with another preferred development, every trigger signal which appears prompts a change of address for the address of a memory cell, and every fresh instance of writing to a memory cell increases the current address in a first internal register.

In line with another preferred development, a start address is stored in a second internal register.

An exemplary embodiment of the invention is illustrated in the drawing and is explained in more detail in the description below.

In the drawing:

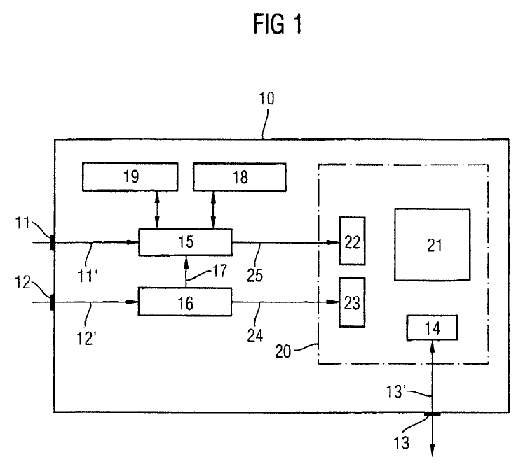

FIG. 1 shows a schematic block diagram of a memory apparatus to explain an embodiment of the present invention.

FIG. 1 shows an extended memory apparatus 10 in line with an embodiment of the present invention. The extended memory apparatus 10 has a trigger input 11 for supplying an external trigger signal 11′, and a control signal input 12 for providing an external control signal 12′. In addition, the extended memory apparatus 10 is provided with a data input/output 13 for interchanging digital data 14. The trigger signal 11′ is supplied to an address generation device 15. The external control signal 12′ is coupled to a control device 16. The control unit 16 is connected via a coupling device 17 to the address generation device 15 for the purpose of actuating this address generation device 15.

The address generation device 15 is coupled to a first address register 18 for storing a current address and to a second address register 19 for storing a start address. In this case, the term “address” always relates to an address for a memory cell. In addition, the extended memory apparatus 10 has a standard memory device 20 containing memory cells 21 for storing the digital data 14. Furthermore, the standard memory device 20 and an address logic device 22 and a control logic device 23. The control device 16 is coupled to the control logic device 23 by means of a coupling device 24. The address generation device 15 is connected to the address logic device 22 by means of a coupling device 25. The address logic device 22 and the control logic device 23 are used to manage the addresses of the memory cells 21 storing the digital data 14 for data interchange, preferably via a multiplicity of data lines 13′.

The control device 16 and the address generation device 15 are responsible for a simplified transmission protocol. On the basis of these two devices 15, 16, address lines and control lines can be reduced to a trigger signal 11′ and a control signal 12′. In this context, the control signal 12′ respectively indicates whether a read operation or a write operation is being requested. The two address registers 18, 19 are used for the address management. When writing or reading data via the data input/output 13, the control signal 12′ is activated. The control device 16 ensures that conventional control signals are generated for forwarding to the control logic device 23, and the addresses are managed in the address generation device 15. Both the reading and writing of digital data 14 in the memory cells 21 are performed using the same protocol.

The address generation device 15 reacts on the basis of the external control signal 11′. When the address generation device 15 is activated using the external trigger signal 11′, either data 14 are read from the memory cells 21 or data 14 are written to the memory cells 21. Every trigger signal 11′ likewise entails a change of address. Every fresh instance of writing data 14 to the memory cells 21 increases the value in the first address register 18 having the current address. The start address of the memory cells 21 is stored in the second address register 19. The address respectively generated by the address generation device 15 on the basis of the trigger signal 11′ and the control signal 12′ is supplied to the address logic device 22 via the coupling device 25, preferably a line.

In line with one preferred embodiment of the present invention, the extended memory apparatus 10, which is preferably integrated on a chip, is used as a FIFO (First In First Out) main memory. In this case, data which are written first are also read first. The addressing is undertaken by the extended memory apparatus 10 in this case. If the first digital data 14, which are supplied via the data input/output 13, are written to the memory cells 21, then the address in the second address register (stored start address) is the same as the current address in the first address register 18. If further externally supplied data 14 are subsequently written to the memory cells 21, a respective next highest address value is used. The respective current address for writing the data 14 to the memory cells 21 is managed in the first address register 18. When data are read, i.e. another external control signal 12′ or signal level is applied to the control device 16, the address from the second address register 19 (stored start address) is accessed. Data 14 are read from the memory cells 21 via the data input/output 13, and the start address is increased in the first address register 18 (current address) so that it points to the next, in line with the example to the second, entry in the memory cells 21. In this way, it is therefore ensured that data 14 written to the memory cells 21 first are also read again first.

In line with another embodiment of the present invention, the main memory can also be used as a FILO (First In Last Out) memory. In line with this embodiment, data 14 supplied externally via the data input/output 13 are written to the memory cells 21 and are read again in reverse order. In this context, the addressing is undertaken by the extended memory apparatus 10, which is preferably integrated on a chip. If the first data 14 are written to the memory cells 21, then the addresses in the first and second address registers 18, 19 (current address, start address) are identical. When further data 14 are written to the memory cells 21, the respective next highest address is used. The respective current address for writing the data 14 to the memory cells 21 is managed in the first address register 18 (current address). When data 14 are read from the memory cells 21, the current address in the first address register 18 is accessed first. When these data have been read, the current address in the first address register 18 is reduced in value. Data can be read until the current address in the first address register 18 becomes the same as the start address stored in the second address register 19, which is monitored by the address generation device 15.

The extended memory apparatus 10 thus essentially has extended control logic 15, 16, 18, 19, with a distinction needing to be drawn only between writing and reading data 14 to and from the memory cells 21. For these decision options, only one external line for supplying the control signal 12′ via the control signal input 12 is required. All of the memory cell address are managed internally in the extended memory apparatus 10, preferably integrated on a chip. Externally, there is thus an additional need for a trigger signal 11′ for managing the memory cell addresses. This trigger signal 11′ requests reading of data or writing of data, depending on the control signal 12′. The addresses are managed in the extended memory apparatus 10 itself.

Although the present invention has been described above with reference to a preferred exemplary embodiment, it is not limited thereto but rather can be modified in a wide diversity of ways. Hence, other storage principles besides the FILO and FIFO storage schemes are also possible.

List of Reference Numerals

10 Extended memory apparatus

11 Trigger input

11′ External trigger signal

12 Control input

12′ Control signal

13 Data input/output

13′ Data lines

14 Digital data

15 Address generation device

16 Control device

17 Coupling device

18 Address register

19 Address register

20 Standard memory device

21 Memory cells

22 Address logic device

23 Control logic device

24 Coupling device

25 Coupling device

1. Apparatus for storing digital data, having:
(a) a multiplicity of memory cells for storing digital data;
(b) an internal address generation device, connected to an address logic device, for managing and generating addresses;
(c) an internal control device, connected to the internal address generation device and a control logic device, for controlling the address generation device and the control logic device;
(d) a trigger input, connected to the internal address generation device, for clocking the internal address generation device;
(e) a control input, connected to the internal control device, for actuating the internal control device; and
(f) a data input/output for interchanging digital data on the basis of a trigger signal and a control signal.

2. Apparatus according to claim 1, wherein a first and a second address register are respectively connected to the address generation device for the purpose of inter-changing addresses.

3. Method for storing digital data, having the following steps:
(a) addresses are managed and generated using an internal address generation device;
(b) the address generation device and a control logic device are controlled using an internal control device;
(c) the internal address generation device is clocked using a trigger signal;
(d) the internal control device is actuated using a control signal;
(e) digital data are interchanged via a data input/output; and
(f) digital data are stored in a multiplicity of memory cells on the basis of the trigger and control signals.

4. Method according to claim 3, wherein a first and a second address register respectively interchange addresses with the address generation device on the basis of the trigger signal and the control signal.

5. Method according to claim 3, wherein the data are stored in the memory cells on the basis of the FIFO principle.

6. Method according to claim 3, wherein the data are stored in the memory cells on the basis of the FILO principle.

7. Method according to claim 3, wherein data are written to the memory cells or are read therefrom when the control signal contains an appropriate external write or read command and the trigger signal appears.

8. Method according to claim 7, wherein every trigger signal which appears prompts a change of address for the address of a memory cell, and in that every fresh instance of writing to a memory cell increases the current address in a first internal register.

9. Method according to claim 3, wherein a start address is stored in a second internal register.
